(19) United States
(12) Patent Application Publication
(10) Pub. No.: US 2016/0267497 A1
(43) Pub. Date: Sep. 15, 2016

(54) MEASURING AN ORGANIZATION'S IMPACT IN A SOCIAL NETWORKING SYSTEM BASED OFF MEMBER INTERACTIONS WITH ORGANIZATION CONTENT

(71) Applicant: LinkedIn Corporation, Mountain View, CA (US)

(72) Inventors: Haipeng Li, Mountain View, CA (US); Paul Hyunwoo Ko, San Francisco, CA (US); Valter Ernesto Sciarrillo, San Francisco, CA (US)

(21) Appl. No.: 14/644,827

(22) Filed: Mar. 11, 2015

(51) Int. Cl. G06Q 30/02; G06Q 50/00

(52) U.S. Cl. CPC G06Q 30/0201; G06Q 50/01

(57) ABSTRACT

System and methods for evaluating an organizations content marketing efforts using large data sets available through social networks are disclosed. A social networking system stores organization data for a plurality of organizations in a database located at a social networking system. The social networking system receives a content marketing score request from a first organization in the plurality of organizations. The social networking system retrieves organization data for the first organization and one or more other organizations. The social networking server determines one or more peer organizations based on the organization data retrieved from the database located at the social networking system. The social networking server then automatically generates content marketing scores for the first organization and the one or more peer organizations and transmits the content marketing scores for the first organization and the one or more peer organizations to a computer system associated with the first organization.

### TECHNICAL FIELD

The disclosed example embodiments relate generally to the field of social networks and in particular to a system for analyzing content impact.

### BACKGROUND

The rise of the computer age has resulted in increased access to personalized services online. As the cost of electronics and networking services drop, many services that were previously provided in person are now provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly. Similarly, online social networking sites allow members to build and maintain personal and business relationships in a much more comprehensive and manageable manner.

One important application of new computer technologies is allowing companies to increase their visibility and contact with current customers and potential customers. For example, social networking sites allow consumers to directly interact with brand managers and, similarly, provides new avenues for content and product producers to communicate with potential consumers. However, traditional methods of measuring and optimizing these interactions are inadequate or often inapplicable.

### DESCRIPTION OF THE DRAWINGS

Some example embodiments are illustrated by way of example and not limitation in the figures of the accompanying drawings, in which:

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4 depicts a block diagram of an exemplary data structure for the organization data for storing organization profiles, in accordance with some example embodiments.

FIG. 5 is a member interface diagram illustrating an example of a member interface, according to some example embodiments.

FIG. 6 is a flow diagram illustrating a method, in accordance with some example embodiments, for automatically generating content marketing scores based on stored organization data, in accordance with an example embodiment.

FIGS. 7A-7C are flow diagrams illustrating a method, in accordance with some example embodiments, for automatically generating content marketing scores based on stored organization data, in accordance with an example embodiment.

FIG. 8 is a block diagram illustrating an architecture of software, which may be installed on any one or more of devices of a computer system.

FIG. 9 is a block diagram illustrating components of a machine, according to some example embodiments.

Like reference numerals refer to corresponding parts throughout the drawings.

### DETAILED DESCRIPTION

The present disclosure describes methods, systems and computer program products for measuring impact of content in a social networking system. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

In some example embodiments, the social networking system stores organization data from a plurality of organizations (e.g., small businesses, corporations, education institutions, non-governmental organizations (NGOs), non-profit organizations, government organizations, and so on). In some example embodiments, the stored data is received explicitly from the organizations. In other example embodiments, the social networking system analyzes existing data to infer some organization data. In some example embodiments, one or more organizations engage on content sharing through the social networking system.

In some example embodiments, the social networking system receives a request to generate a content marketing score for a respective organization in the one or more organizations that engage in content sharing (e.g., paid or unpaid advertising or messaging) on the social networking system. In response, the social networking system generates a group of peer organizations (e.g., organizations that are relevant comparisons for the respective organization based on business type, size, revenue, location, and so on). In some example embodiments, the list of peer organizations is based on a customized list received from a client system along with the request. In other example embodiments, the social networking system generates a list of peer organizations based on stored organization data, including common social connections, location, size of organization, organization purpose or business field, and so on.

In some example embodiments, once the peer organizations have been identified, the social networking system generates a content marketing score for each. In some example embodiments, a content marketing score for a first organization is generated by measuring the number of unique social interactions (e.g., clicks, likes, shares, up-votes, comments, follow, subscribe, donate, purchase, and so on) with content associated with the first organization (e.g., advertisements, sponsored content, groups, influencer posts, employee posts, organization posts, and so on).

The total active audience is then measured for the entire peer group. The total active audience is all members who have been active (e.g., based on last login/number of times logging on per year) that fit within the audience parameters set by the organizations. In some example embodiments, the audience can be limited to certain people/certain roles for a more specialized content marketing score. In some example embodiments, the content marketing score is generated based on the ratio of unique social interactions for content items associated with a specific organization and the total active audience for the entire peer group.

In some example embodiments, the social networking system then transmits the generated scores to the requesting client system. In some example embodiments, the social networking system also transmits recommendations for improving the content management score for an organization.

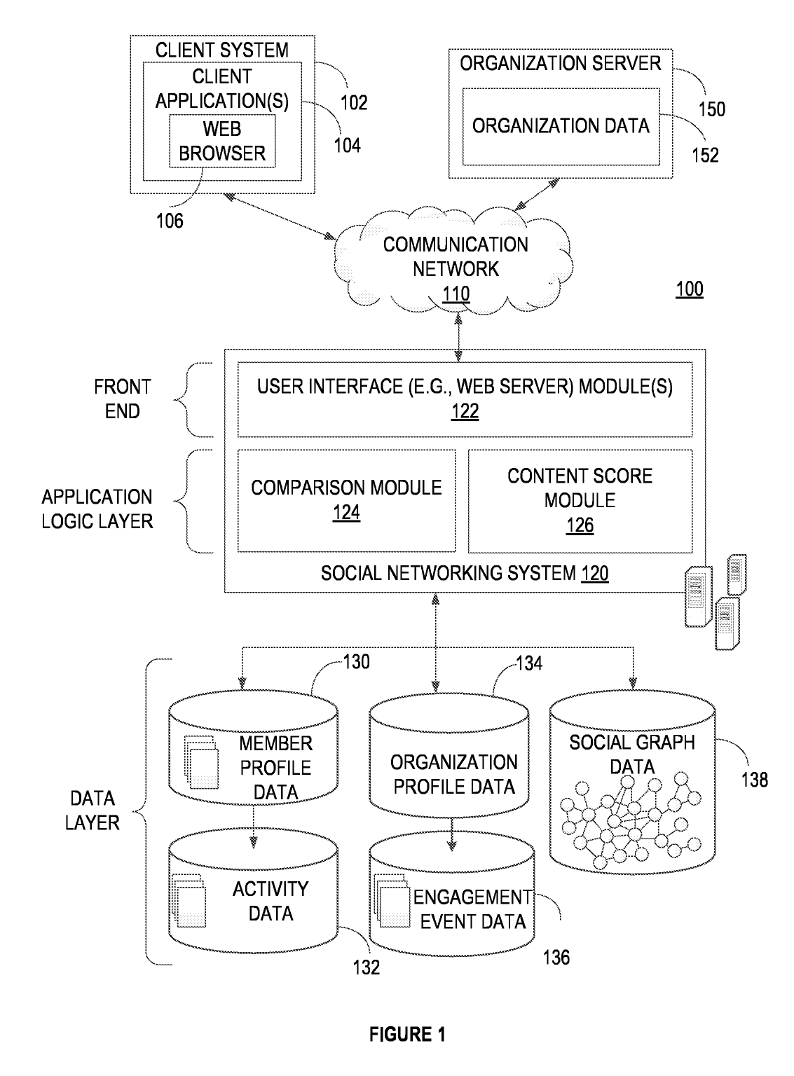

FIG. 1 is a network diagram depicting a client-social networking system environment 100 that includes various functional components of a social networking system 120, in accordance with some example embodiments. The client-social networking system environment 100 includes one or more client systems 102, a social networking system 120, and one or more other organization servers 150. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser 106. The client system 102 uses the web browser 106 to communicate with the social networking system 120 and displays information received from the social networking system 120. In some example embodiments, the client system 102 includes an application specifically customized for communication with the social networking system 120 (e.g., a LinkedIn iPhone application). In some example embodiments, the social networking system 120 is a server system that is associated with a social networking service. However, the social networking system 120 and the server system that actually provides the social networking service may be completely distinct computer systems.

In some example embodiments, the client system 102 sends a request to the social networking system 120 for a webpage associated with the social networking system 120 (e.g., the client system 102 sends a request to the social networking system 120 for an updated list of activity). For example, a member of the client system 102 logs onto the social networking system 120 and clicks on a link to their home page that includes a list of recent activities of the member on the social networking system 120. In response, the client system 102 receives the requested data (e.g., information about schools and enrollment) and displays them on the client system 102.

In some example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various example embodiments are by no means limited to this architecture.

As shown in FIG. 1, the front end consists of a user interface module(s) (e.g., a web server) 122, which receives requests from various client systems 102, and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, activity data 132 (e.g., data describing the activities of members in the social networking system 120 including, but not limited to, clicks, likes, comments, posts, and so on), organization profile data 134 (e.g., data about one or more companies), engagement event data 136 (data describing engagement events for companies), and social graph data 138, which is stored in a particular type of database that uses graph structures with nodes, edges, and properties to represent and store data. Of course, with various alternative example embodiments, any number of other entities might be included in the social graph (e.g., companies, organizations, schools and universities, religious groups, non-profit organizations, and any other group), and as such, various other databases may be used to store data corresponding with other entities.

Consistent with some example embodiments, when a person initially registers to become a member of the social networking system 120, the person will be prompted to provide some personal information, such as his or her name, age (e.g., birth date), gender, interests, contact information, home town, address, educational background (e.g., schools, majors, etc.), current job title, job description, industry, employment history, skills, professional organizations, and so on. This information is stored, for example, in the member profile data 130. In some example embodiments, the social networking system 120 will also prompt the person to determine whether that person is interested in attending one or more schools in the future.

In some example embodiments, the member profile data 130 includes activity data 132. In other example embodiments, the activity data 132 is distinct from, but associated with, the member profile data 130. The activity data 132 stores data related to activities taken by members of the social networking system (e.g., system 120 in FIG. 1) through the social networking system. Activities include, but are not limited to, page views, clicks, profile views, likes, shares, posts, and so on.

In some example embodiments, the organization profile data 134 stores data related to companies represented on the social networking system 120 and their employees. In some example embodiments, specific members of the social networking system 120 are associated with particular companies (e.g., they list an organization as an employer). In some example embodiments, organization profile data includes, but is not limited to, organization locations (e.g., headquarters locations, store/facility/production/retail locations, organization size, market sector(s), employees, revenues, past interactions with the social networking system 120, and so on).

In some example embodiments, the engagement event data 136 includes group activity, influencer posts, organization posts, sponsored posts, employee posts, sponsored updates, and so on. In some example embodiments, the engagement events are events that were explicitly paid for by an organization. In other example embodiments, engagement events are events that results from routine, unpaid, member interaction on the social networking system 120 (e.g., an employee posts about a new product).

Once registered, a member may invite other members, or be invited by other members, to connect via the network service. A “connection” may include a bi-lateral agreement by the members, such that both members acknowledge the establishment of the connection. Similarly, with some example embodiments, a member may elect to “follow” another member. In contrast to establishing a “connection,” the concept of “following” another member typically is a unilateral operation and, at least with some example embodiments, does not include acknowledgement or approval by the member that is being followed. When one member follows another, the member who is following may receive automatic notifications about various activities undertaken by the member being followed. In addition to following another member, a member may elect to follow an organization, a topic, a conversation, or some other entity, which may or may not be included in the social graph. Various other types of relationships may exist between different entities and are represented in the social graph data 138.

The social networking system 120 may provide a broad range of other applications and services that allow members the opportunity to share and receive information, which is often customized to the interests of the member. In some example embodiments, the social networking service may include a photo sharing application that allows members to upload and share photos with other members. As such, at least with some example embodiments, a photograph may be a property or entity included within a social graph. With some example embodiments, members of a social networking service may be able to self-organize into groups, or interest groups, organized around a subject matter or topic of interest. In some example embodiments, the data for a group may be stored in a database. When a member joins a group, his or her membership in the group will be reflected in the organization activity data, the member activity data, and the social graph data stored in the social graph data 138.

In some example embodiments, the application logic layer includes various application server modules, which, in conjunction with the user interface module(s) 122, generates various user interfaces (e.g., web pages) with data retrieved from various data sources in the data layer. With some example embodiments, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize a comparison module 124 or a content score module 126 may be separately implemented in their own application server modules.

In addition to the various application server modules, the application logic layer includes a comparison module 124 and a content score module 126. As illustrated in FIG. 1, with some example embodiments, the comparison module 124 and content score module 126 are implemented as services that operate in conjunction with various application server modules. For instance, any number of individual application server modules can invoke the functionality of the comparison module 124 or the content score module 126 to determine a first organization's standing in effectively using a social networking system 120 relative to other similar organizations. However, with various alternative example embodiments, the comparison module 124 or the content score module 126 are implemented as their own application server module such that the modules operates as a stand-alone application. With some example embodiments, the comparison module 124 or the content score module 126 include or have an associated publicly available API that enables third-party applications to invoke the functionality they provide.

Generally, the comparison module 124 module determines, based on organization profile data 134 stored at the social networking system 120, companies that would make a good comparison for a first organization (e.g., companies that are similar or operate in similar fields). In some example embodiments, the comparison module 124 determines a list of peer companies by identifying an industry sector for the first organization. In some example embodiments, the comparison module 124 also determines the first company's size, revenue, location, and number of employees.

Based on the gathered data for the first organization and potential peer companies, the comparison module 124 gives each potential peer organization a score, with the score representing the degree to which each potential peer organization is similar to the first organization.

In some example embodiments, the comparison module 124 ranks each potential peer organization based on the generated scores, such that the organizations with the highest scores are the most likely to be peers of the first organization. In some example embodiments, the comparison module 124 then selects a predetermined number of the potential peer organizations with the highest rank (e.g., the top ten or the top twenty and so on) and uses them as the peer group for the first organization.

In some example embodiments, the first organization sends a request for comparison and includes one or more organizations to include in the peer group. In this case, the one or more organizations selected by the requesting first organization are used as the peer group, with other organizations being added only if the number of selected organizations are below the predetermined number of organizations needed for comparison.

In some example embodiments, the content score module 126 uses stored information about engagement event data 136 to generate a content score for a requesting first organization and a peer group of organizations determined by the comparison module 124.

In some example embodiments, generating a content marketing score for a first organization includes determining the number of unique members who engage with content from the first organization. Content from the first organization includes paid advertising from the first organization, such as sponsored updates or posts, actions that the organization officially takes on the social networking system 120 (such as status updates or normal posts), and actions taken by members who are associated with the first organization (e.g., employees, owners, customers, and so on), such as commenting, sharing, blog posts, and so on.

In some example embodiments, once the content score module 126 identifies the content associated with the first organization, it then determines the number of unique members that have interacted with the content in some way. For example, a member that likes, shares, or comments on a sponsored post is determined to have interacted with the sponsored post. The content score module 126 then determines the number of active unique members in the audience. In some example embodiments, a member is considered active if the member has logged onto the social networking system 120 at least once in the past month. Other lengths of time or methods of determining whether a member is active can be used.

In some example embodiments, the audience includes all active members of the social networking servers. In other example embodiments, the audience is defined to be more focused and includes only individuals that fit filter criteria given by the first organization or by an individual preparing a presentation for the first organization. For example, the first organization determines that only members with a certain roles are to be used in the potential audience. A first organization only wants members that are in human resources in Fortune 500 company. In some example embodiments, only interactions from members of the selected audience are used to generate the content marketing score.

In some example embodiments, the content score module 126 calculates a content marketing score for the first organization and the peer organizations by calculating the ratio of unique member interactions to the size of the active member audience. In some example embodiments, the content marketing scores represent a relative position in the peer group for each organization such that organizations with a high member engagement (e.g., the highest ratio of unique member interactions to unique audience members) have higher content marketing scores than organizations with low member engagement.

In some example embodiments, the organization server 150 is a server system that is located remotely from the social networking system 120 and is associated with a particular organization. The organization server connects to the social networking system 120 via the communication network 110. In some example embodiments, the organization server 150 stores organization data 152 related to the organization.

In some example embodiments, the organization server 150 sends a request to the social networking system 120 to determine a content marketing score for the organization associated with the organization server 150. In some example embodiments, the request includes a target audience (e.g., criteria for members to be considered) and a list of one or more peers. In some example embodiments, the organization server 150 receives a response from the social networking system 120 that includes a content marketing score for the associated organization and one or more organizations in the organization's peer group.

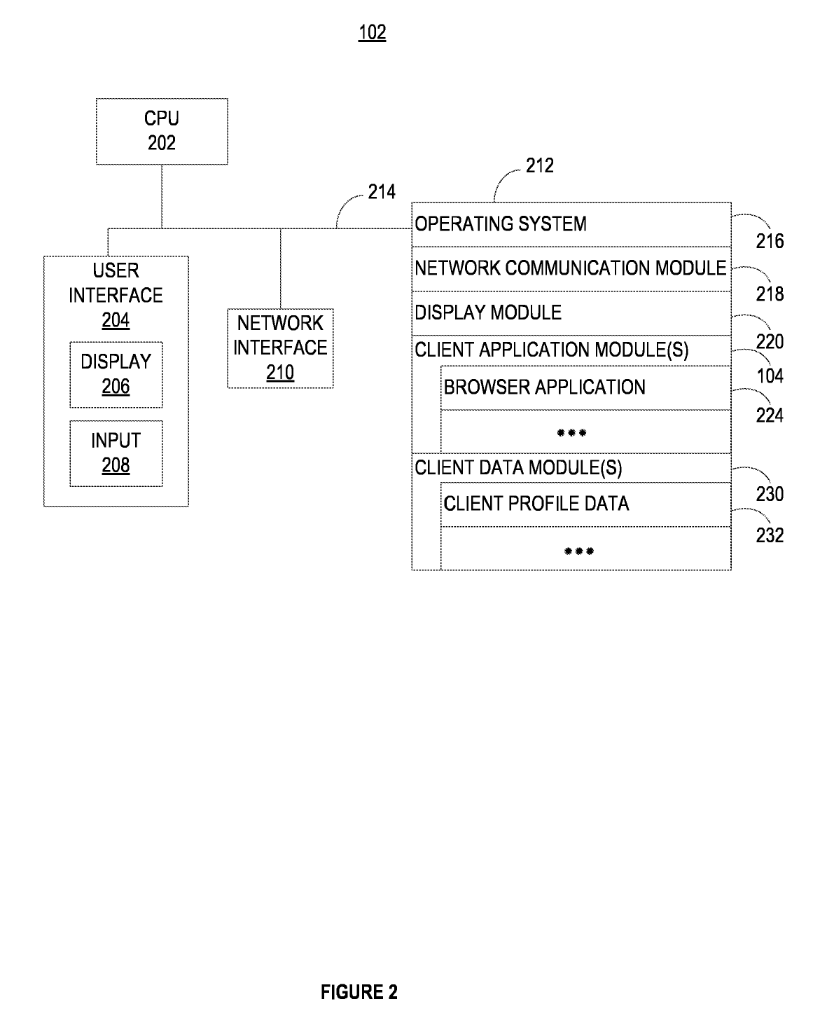

FIG. 2 is a block diagram illustrating a client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display 206 and optionally includes an input means such as a keyboard, mouse, touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer readable storage medium.

In some example embodiments, memory 212 or the computer-readable storage medium of memory 212 stores the following programs, modules, and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks, such as the Internet, other WANs, LANs, metropolitan area networks (MANs), etc.;
a display module 220 for enabling the information generated by the operating system 216 and client applications 104 to be presented visually on the display 206;
one or more client applications 104 for handling various aspects of interacting with the social networking system 120 (FIG. 1), including but not limited to:
   a browser application 224 for requesting information from the social networking system 120 (e.g., product pages and member information) and receiving responses from the social networking system 120; and
a client data module(s) 230, for storing data relevant to the clients, including but not limited to:
   client profile data 232 for storing profile data related to a member of the social networking system 120 associated with the client system 102.

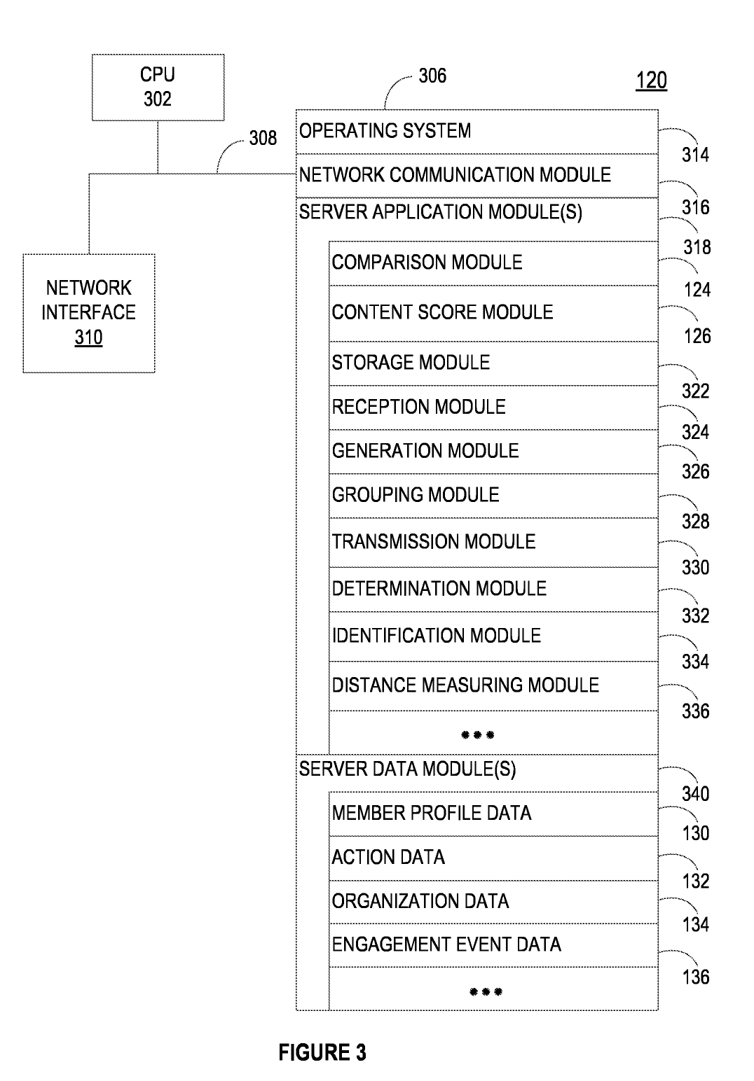

FIG. 3 is a block diagram further illustrating the social networking system 120, in accordance with some example embodiments. The social networking system 120 typically includes one or more CPUs 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer readable storage medium. In some example embodiments, memory 306, or the computer readable storage medium of memory 306, stores the following programs, modules, and data structures, or a subset thereof:
an operating system 314 that includes procedures for handling various basic system services and for performing hardware dependent tasks;
a network communication module 316 that is used for connecting the social networking system 120 to other computers via the one or more communication network interfaces 310 (wired or wireless) and one or more communication networks, such as the Internet, other WANs, LANs, MANs, and so on;
one or more server application modules 318 for performing the services offered by social networking system 120, including but not limited to:
   a comparison module 124 for analyzing a plurality of organizations, determining various attributes, and determining which organizations in the plurality of organizations are appropriate to place into a peer group for a first organization;
   a content score module 126 for generating a content marketing score for one or more organizations based on each organization's success in generating member interaction with content from the organization;
   a storage module 322 for storing activity data 132, engagement event data 136, and any social graph data 138 associated with the social networking system 120;
   a reception module 324 for receiving requests and data from one or more client systems (e.g., client system 102 in FIG. 1);
   a generation module 326 for generating content marketing scores for one or more organizations;
   a grouping module 328 for grouping one or more organizations into one or more peer groups;
   a transmission module 330 for transmitting content marketing scores to a client system (e.g., client system 102 in FIG. 1);
   a determination module 332 for determining the number of engagement events, the number of members in an active target audience, and a ratio of engagement events to active target audience members;
   an identification module 334 for identifying the groups of audience members from the plurality of members of the social networking system 120;
   a distance measuring module 336 for determining the relative distance between two organizations, based on the social connections of members associated with each organization; and
server data module(s) 334, holding data related to social networking system 120, including but not limited to:
   member profile data 130 including both data provided by the member, who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on member activity, social graph data, and overall trend data for the social networking system 120, and so on;
   activity data 132 including data that represents the various actions that members of the social networking system 120 can take including, but not limited to, clicks, views, posts, shares, linking, updates, and so on;
   organization profile data 134 including data stored for each organization including but not limited the organizations, name, location, business sector, employees, legal status, revenue, and so on, and
   engagement event data 136 including interactions with sponsored posts, updates, member posts, sponsored updated, and so on.

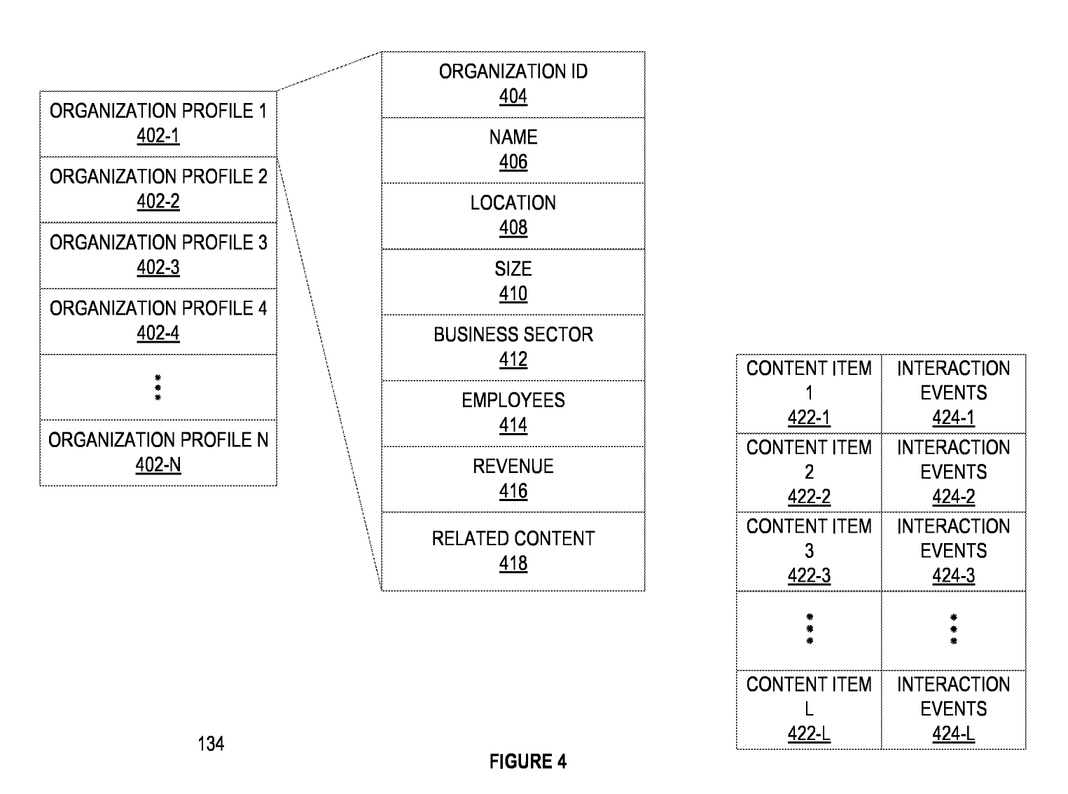

FIG. 4 depicts a block diagram of an exemplary data structure for the organization profile data 134 for storing organization profiles, in accordance with some example embodiments. In accordance with some example embodiments, the organization profile data 134 includes a plurality of organization profiles 402-1 to 402-N, each of which corresponds to an organization with a profile on the social networking server system (FIG. 1, 120).

In some example embodiments, a respective organization profile 402 stores a unique organization identification (ID) 404 for the organization profile 402, a name 406 for the organization (e.g., the organization's legal name), the location 408 of the organization, the size of the organization 410, the business sector or sectors 412 that the organization deals with, the organization's employees 414, the revenue 416 of the organization, and content 418 published on the social networking system (e.g., system 120 in FIG. 1) that is related to the organization.

In some example embodiments, the organization's location 408 includes a list of locations with which the organization is associated including offices, headquarters, campuses, manufacturing plants, warehouses, retail stores, and so on. In some example embodiments, the size of an organization 410 is the number of employees that an organization has. In other example embodiments, the size of an organization 410 represents the total book value of an organization.

In some example embodiments, the business sector 412 of an organization represents the one or more areas of business, commerce, or non-profit activity that the organization engages in. In some example embodiments, the list of employees 414 includes links to the member profiles of all the members who are associated with the organization and includes employees, managers, owners, and so on. In some example embodiments, the revenue 416 includes information describing the average or expected revenue of the organization.

In some example embodiments, an organization profile 402 includes a list of content items (422-1 to 422-L) associated with the organization and any interaction events (424-1 to 424-L) associated with each content item. Each content item represents a specific piece of content associated with the organization including, but not limited to, influencer posts, organization posts, sponsored posts, employee posts, sponsored updates, group posts, and so on. The social networking system (e.g., system 120 in FIG. 1) allows members to interact with content items (e.g., posts) in a variety of ways.

In some example embodiments, each content item 422 includes a list of interaction events 424 that are associated with that item. In some example embodiments, the interaction events 424 also include the member who performed the specific interaction. In some example embodiments, interaction events include clicks, likes, follows, shares, comments, posts, and so on.

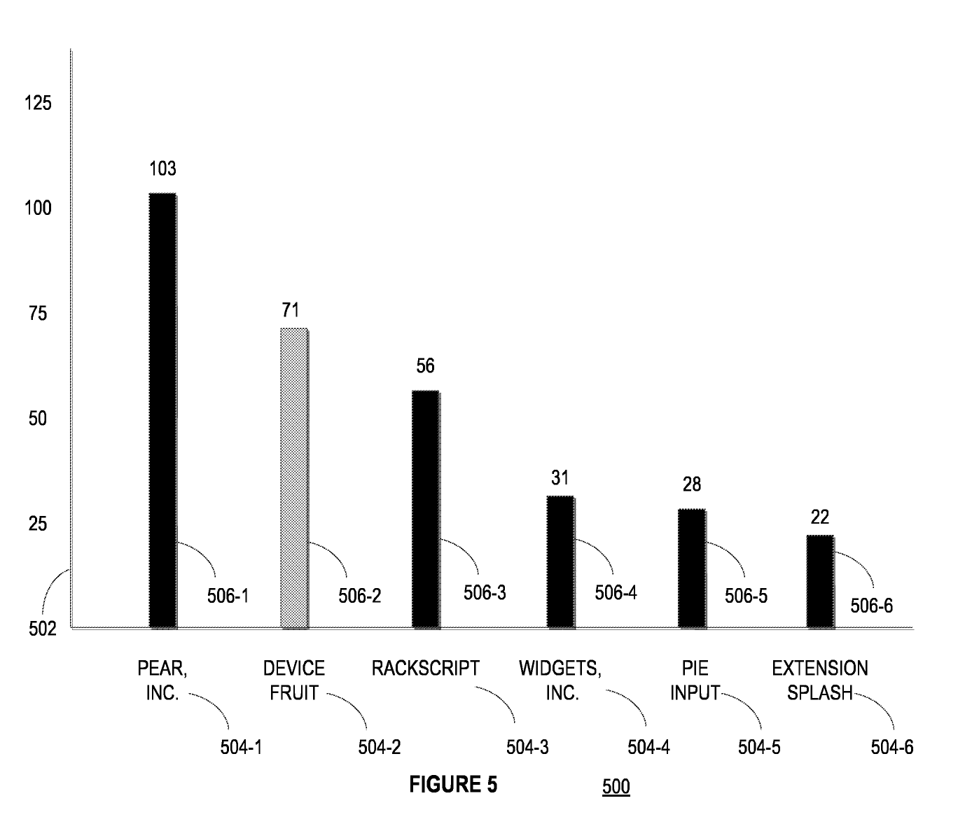

FIG. 5 is a member interface diagram illustrating an example of a user interface 500 that includes a chart 502 displaying a set of content marketing scores for a plurality of organizations in a peer group.

In some example embodiments, the user interface 500 displays content marketing scores for a series of organizations in a bar chart format, with each content marketing score being represented as a bar above the name of the organization with which it is associated.

In some example embodiments, the chart 502 includes a plurality of organization names (504-1 to 504-6) below the x-axis line. Above each organization name are bars, with each bar (506-1 to 506-6) representing a content marketing score for the organization above whose name it is positioned. For example, the organization Pear, Inc. (504-1) has a bar chart above it. The bar chart associated with Pear, Inc. (506-1) represents a content marketing score of 103 and has the highest content marketing score in the displayed peer group. The numerical value of a displayed bar is displayed such that it is positioned directly above the corresponding bar.

In some example embodiments, the organization that requested the content marketing score be performed (or on whose behalf it was performed) is visually distinguished among the group of peer organizations. In the example displayed, the bar displayed for Device Fruit (504-2) is distinguished from the other organizations based on the color of the bar itself (e.g., grey rather than black). In some example embodiments, any other suitable method can be used to visually distinguish one or more organizations.

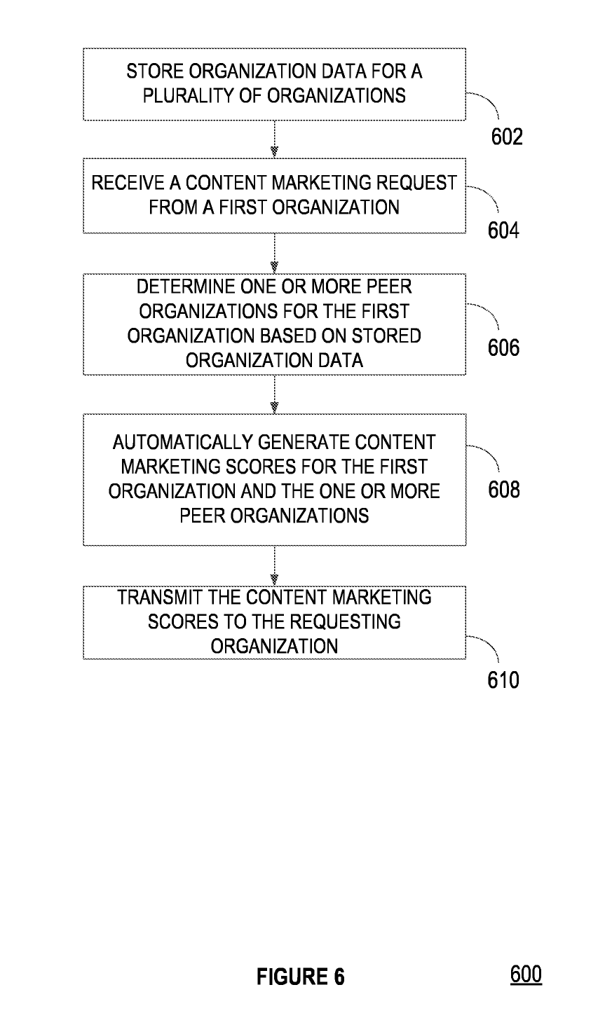

FIG. 6 is a flow diagram illustrating a method 600 for automatically generating content marketing scores based on stored organization data, in accordance with an example embodiment. Each of the operations shown in FIG. 6 corresponds, in some embodiments, to instructions stored in a computer memory or computer readable storage medium. In some example embodiments, the method 600 described with reference to FIG. 6 is performed by a social networking system (e.g., system 120 in FIG. 1).

In some example embodiments, the social networking system (e.g., social networking system 120 of FIG. 1) stores (602) organization data for a plurality of organizations registered with or represented on a social networking system (e.g., system 120 in FIG. 1). For example, a social networking system (e.g., system 120 in FIG. 1) allows companies to establish profiles on the social networking system (e.g., system 120 in FIG. 1) in order to reach members of the social networking system (e.g., system 120 in FIG. 1) and interact more closely with consumers. As part of the registration process, the social networking system (e.g., system 120 in FIG. 1) collects information about the organization, including size, location, employees, business sectors, products and services, and so on. All this data can then be stored in a database at (or accessible to) the social networking system (e.g., system 120 in FIG. 1).

In some example embodiments, the social networking system (e.g., system 120 in FIG. 1) receives (604) a content marketing score request from a first organization. In some example embodiments, the request is received from a party preparing information for the first organization (e.g., a presentation). In some example embodiments, the request includes a list of peer organizations, against which the first organization should be compared. In some example embodiments, the request includes a target audience designation. The target audience designation identifies the members of the social networking system (e.g., system 120 in FIG. 1) that are important to the first organization (for example, the first organization is interested in the interactions of members whose occupation involves sales).

In some example embodiments, the social networking system (e.g., system 120 in FIG. 1) determines (606) one or more peer organizations for the first organization based on stored organization data. For example, the social networking system (e.g., system 120 in FIG. 1) compares the size, location, business sector, and revenue of one or more other organizations and finds one or more organizations that are most similar to the first organization. In some example embodiments, a variety of different algorithms or methods can be used to determine the most similar organizations.

In some example embodiments, the social networking system (e.g., system 120 in FIG. 1) automatically generates (608) content marketing scores for the first organization and the one or more peer organizations. In some example embodiments, the content marketing score is determined based on identifying the total number of unique member interactions with content associated with a first organization and the total number of members in the target audience. In some example embodiments, the content marketing score is then determined based on the ratio between the total number of unique member interactions and the total number of members in the target audience.

In some example embodiments, the social networking system (e.g., system 120 in FIG. 1) then transmits (610) the content marketing scores (e.g., for the first organization and the determined peer organizations) to a computer system associated with the first organization.

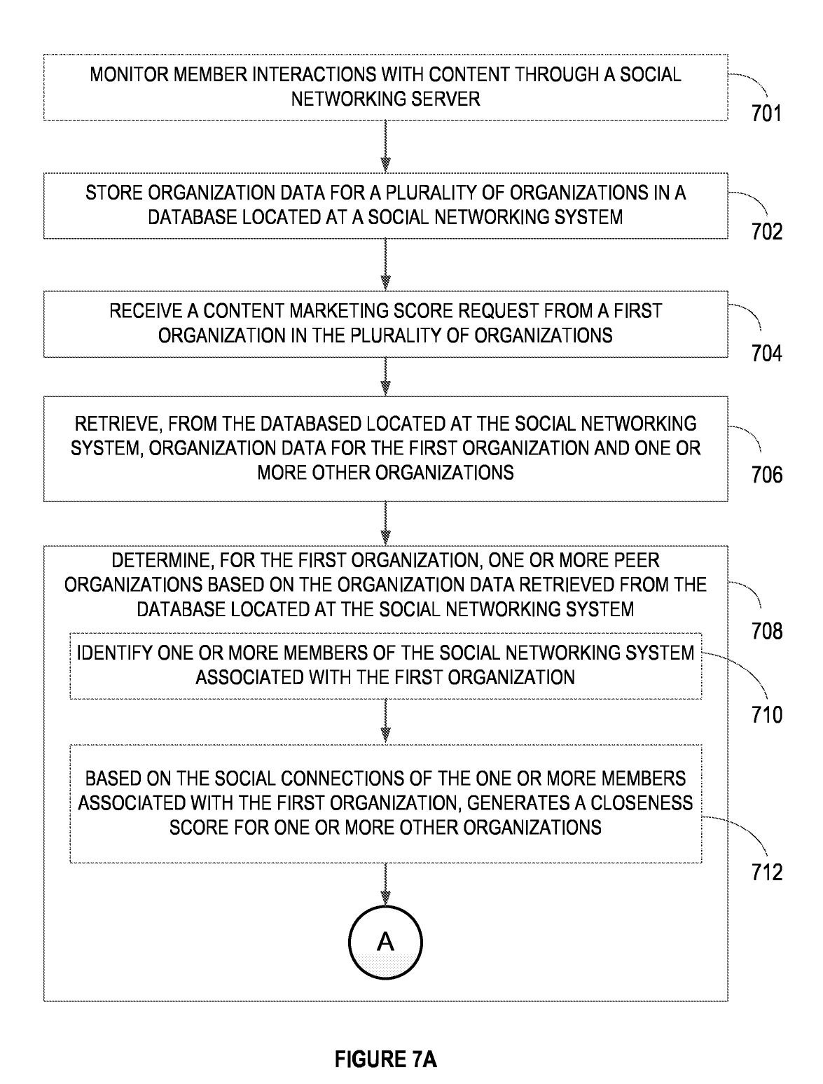

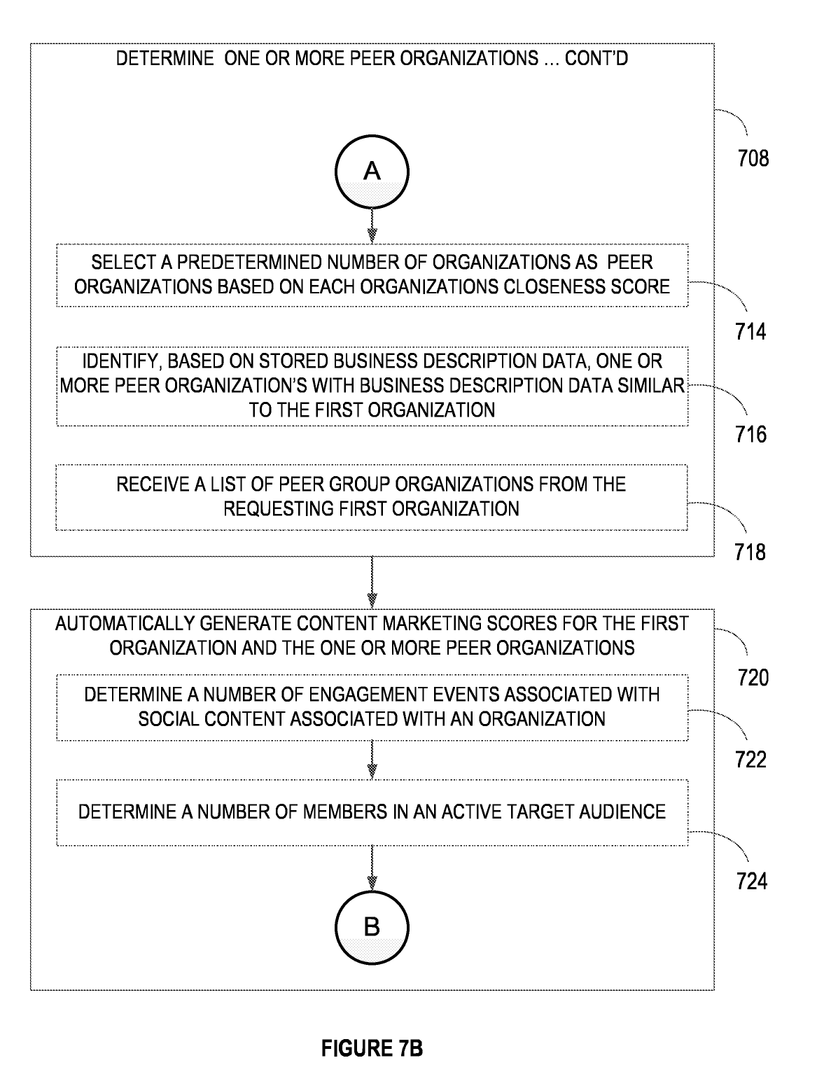

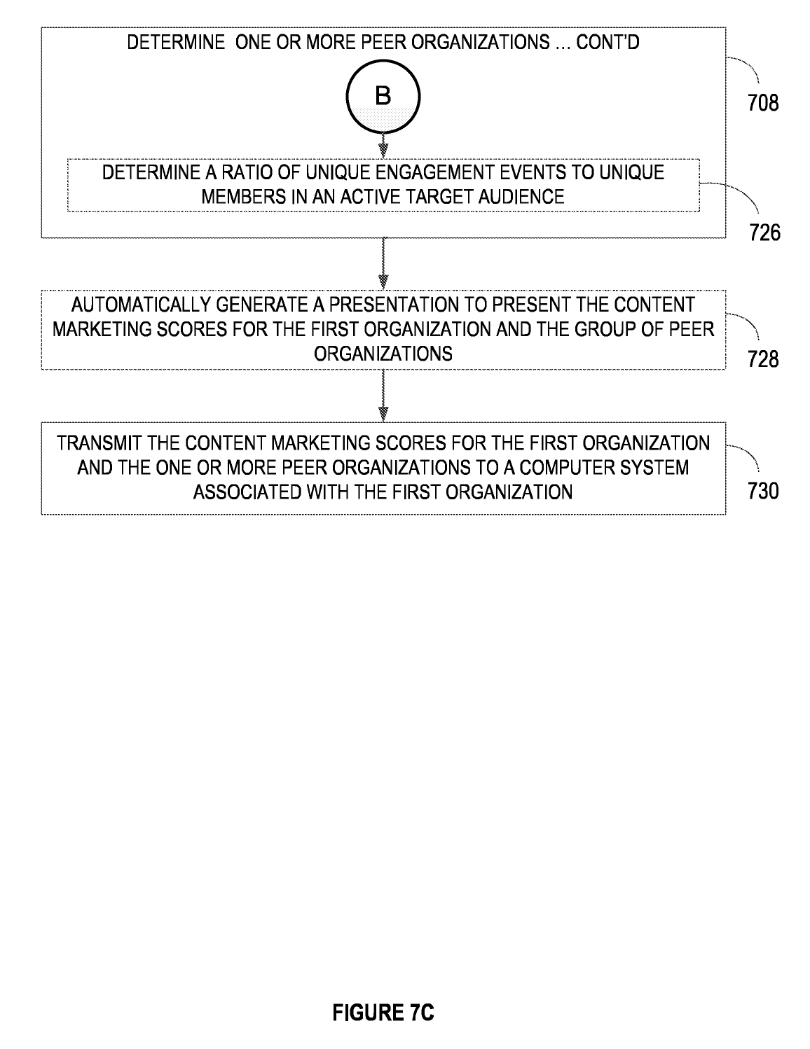

FIG. 7A is a flow diagram illustrating a method, in accordance with some example embodiments, for determining the effectiveness of content in a social networking system based on member interactions. Each of the operations shown in FIG. 7A may correspond to instructions stored in a computer memory or computer-readable storage medium. Optional operations are indicated by dashed lines (e.g., boxes with dashed-line borders). In some embodiments, the method described in FIG. 7A is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) monitors (701) member interactions with content (e.g., posts, blog updates, and so on) that is hosted through the social networking system (e.g., system 120 in FIG. 1). In some example embodiments, the social networking system (e.g., system 120 in FIG. 1) is host to millions (or hundreds of millions) different social interactions, resulting in a very large data set. In some example embodiments, interaction data is stored only for members who consent to have their interactions stored.

In some example embodiments, the social networking system (e.g., system 120 in FIG. 1) stores (702) organization data for a plurality of organizations in a database located at a social networking system (e.g., system 120 in FIG. 1). In some example embodiments, organization data includes social interaction data for content associated with the organization. For example, the organization data includes a list of content items associated with a particular organization (e.g., sponsored posts, sponsored updates, blog posts, organization posts, employee posts) and, for each content item, a list of each user interaction (e.g., likes, shares, follows, up votes, and so on).

In some example embodiments, organization data includes a list of members associated with each organization and the social connections of those members. For example, the organization includes a list of employees, owners, and other stakeholders for an organization. In some example embodiments, the data is only stored for members that consent to have their information used in this way.

In some example embodiments, organization data includes business description data, including, but not limited to, the size of the organization, the location of the organization, and the business sector of the organization.

In some example embodiments, the social networking system (e.g., system 120 in FIG. 1) receives (704) a content marketing score request from a computer system associated with a first organization in the plurality of organizations. In some example embodiments, the content marketing score request is received from the computer system associated with the first organization.

In some example embodiments, determining one or more peer organizations comprises the social networking system (e.g., system 120 in FIG. 1) receiving a list of peer group organizations from the requesting first organization. For example, an organization is interested in how they fit in a specific group of competitors. In this case, the organization includes a list of their self-determined peer organizations with its content marketing score request.

In some example embodiments, the social networking system (e.g., system 120 in FIG. 1) retrieves (706), from the databased located at the social networking system, organization data for the first organization and one or more other organizations.

In some example embodiments, the social networking system (e.g., system 120 in FIG. 1) determines (708), for the first organization, one or more peer organizations based on the organization data retrieved from the database located at the social networking system (e.g., system 120 in FIG. 1). In some example embodiments, determining one or more peer organizations comprises the social networking system (e.g., system 120 in FIG. 1) identifying (710) one or more members of the social networking system associated with the first organization. For example, the social networking system (e.g., system 120 in FIG. 1) identifies one or more members of the social networking system (e.g., system 120 in FIG. 1) that have listed the first organization as an employer.

In some example embodiments, based on the social connections of the one or more members associated with the first organization, the social networking system (e.g., system 120 in FIG. 1) generates (712) a closeness score for one or more other organizations, wherein the closeness score for a particular organization represents the number of members associated with the particular organization that have social connections to the one or more members associated with the first organization. For example, for each potential respective peer organization, the social networking system (e.g., system 120 in FIG. 1) determines how many employees of the first organization have social connections with one or more employees of the respective potential peer organization. Respective potential peer organizations with more connections are more likely to be a peer organization to the first organization.

FIG. 7B is a flow diagram illustrating a method, in accordance with some example embodiments, for determining the effectiveness of content in a social networking system based on member interactions. Each of the operations shown in FIG. 7B may correspond to instructions stored in a computer memory or computer-readable storage medium. Optional operations are indicated by dashed lines (e.g., boxes with dashed-line borders). In some embodiments, the method described in FIG. 7B is performed by the social networking system (e.g., system 120 in FIG. 1). However, the method described can also be performed by any other suitable configuration of electronic hardware. In some example embodiments, FIG. 7B continues the method shown in FIG. 7A.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) selects (714) a predetermined number of organizations as peer organizations based on each organization's closeness score. For example, the social networking system (e.g., system 120 in FIG. 1) selects the five organizations with the highest closeness scores as the peer group for the first organization.

In some example embodiments, the social networking system (e.g., system 120 in FIG. 1) identifies (716), based on stored business description data, one or more peer organizations with business description data similar to the first organization. For example, the social networking system (e.g., system 120 in FIG. 1) determines organizations within a given distance of the first organization, with similar revenues and in the same business sectors as peer organizations.

In some example embodiments, the social networking system (e.g., system 120 in FIG. 1) receives (718) a list of peer group organizations from the requesting first organization. In this way, an organization can define their own peer group or select organizations in the peer group they ideally would like to be in.

In some example embodiments, the social networking system (e.g., system 120 in FIG. 1) automatically generates (720) content marketing scores for the first organization and the one or more peer organizations.

In some example embodiments, the social networking system (e.g., system 120 in FIG. 1) determines (722) a number of engagement events associated with social content associated with an organization. For example, the social networking system (e.g., system 120 in FIG. 1) retrieves interaction data associated with the first organization. Interaction data includes any likes, shares, follows, up votes, reposts, and so on for content posted by or related to the first organization. In some example embodiments, the social networking system (e.g., system 120 in FIG. 1) both records and stores all the interactions in a database. In some example embodiments, the social networking system (e.g., system 120 in FIG. 1) also removes replicate actions (e.g., a member linking to a post twice) such that only unique interactions are counted.

In some example embodiments, the social networking system (e.g., system 120 in FIG. 1) determines (724) a number of members in an active target audience. The active target audience includes any member that has logged into the social networking system (e.g., system 120 in FIG. 1) within a certain amount of time (e.g., one month). In some example embodiments, the requesting party (e.g., the first organization) can include parameters that are used to determine the target audience. For example, the first organization sets the audience to female members between 18 and 35 in Colorado.

FIG. 7C is a flow diagram illustrating a method, in accordance with some example embodiments, for determining the effectiveness of content in a social networking system based on member interactions. Each of the operations shown in FIG. 7C may correspond to instructions stored in a computer memory or computer-readable storage medium. Optional operations are indicated by dashed lines (e.g., boxes with dashed-line borders). In some embodiments, the method described in FIG. 7C is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) determines (726) a ratio of unique engagement events to unique members in an active target audience. In some example embodiments, content marketing scores are generated such that a content marketing score for a first organization represents a relative position of the first organization in the group of peer organizations.

In some example embodiments, a content marketing score can be broken down based on three categories: reach of the content, frequency of shared content, and quality of content. Reach represents the number of members who see (e.g., in their activity feed) a particular piece of content. Frequency refers to how often content is shared from the first organization. Quality of content refers to how good each piece of content is at encouraging interactions from members of the social networking system (e.g., system 120 in FIG. 1).

Thus, when the social networking system (e.g., system 120 in FIG. 1) calculates a content marketing score for a particular organization, the social networking system (e.g., system 120 in FIG. 1) can determine how each of the three key categories are represented in the content marketing score. For example, if an organization has a relatively low content marketing score, the social networking system (e.g., system 120 in FIG. 1) can determine which of the three categories is the most lacking.

In some example embodiments, the content is actually presented to a very small fraction of the target audience. For example, the social networking system (e.g., system 120 in FIG. 1) can calculate the percentage of the target audience that actually viewed the content (e.g., the members that actually received a generated webpage from the social networking system (e.g., system 120 in FIG. 1) and that actually displayed on the screen). The social networking system (e.g., system 120 in FIG. 1) can then compare the percentage of the target audience that had actually viewed the content associated with the corresponding percentage of each of the peer group organizations. In accordance with a determination that the first organization has an actually viewed percentage significantly lower than the peer group average, the social networking system (e.g., system 120 in FIG. 1) determines that a significant reason for a low content marketing score is lack of reach.

In some example embodiments, in accordance with a determination that a significant reason for a low content marketing score is lack of reach, the social networking system (e.g., system 120 in FIG. 1) can suggest potential alternative solutions, including, but not limited to, increasing the number of following members, changing the times when content is released to prime-time hours (e.g., work hours if the target audience is professionals), increasing the advertising budget to increase reach, and so on.

In another example, the social networking system (e.g., system 120 in FIG. 1) determines that Organization B has a low marketing score. The social networking system (e.g., system 120 in FIG. 1) can calculate the average response rate for content items for Organization B. This average response rate (e.g., how many response or interactions a particular piece of content will receive, on average), can be compared to the average response rate for other members of Organization B's peer group. If Organization B's average response rate is lower than the average of their peer group, then the social networking system (e.g., system 120 in FIG. 1) determines that the quality of the content items is a significant reason for the relative low content marketing score.

In some example embodiments, in accordance with a determination that a significant reason for a low content marketing score is content item quality, the social networking system (e.g., system 120 in FIG. 1) can suggest potential alternative solutions, including, but not limited to, changing the type of content items (e.g., some content items may be more successful in engaging members than others), changing the topics of the content items, investing more time/money on content producing, and so on.

In another example, the social networking system (e.g., system 120 in FIG. 1) determines that Organization B has a low marketing score. The social networking system (e.g., system 120 in FIG. 1) can calculate the average number of content items per day, per week, or per month for Organization B. This calculated average content item post rate can be compared to the average content item post rate for other members of Organization B's peer group. If Organization B's average content item post rate is lower than the average of their peer group, then the social networking system (e.g., system 120 in FIG. 1) determines that Organization B posts content items too infrequently to have a relatively high marketing score. In some example embodiments, the social networking system (e.g., system 120 in FIG. 1) suggests that Organization B post content items more frequently.

In some example embodiments, the social networking system (e.g., system 120 in FIG. 1) automatically generates (728) a presentation to present the content marketing scores for the first organization and the group of peer organizations. In some example embodiments, the presentation is a slideshow presentation with detailed information about an organization's content marketing score, its peer group, and the areas in which the organization may want to improve.

In some example embodiments, the social networking system (e.g., system 120 in FIG. 1) transmits (730) the content marketing scores for the first organization and the one or more peer organizations to a computer system associated with the first organization.

### Software Architecture

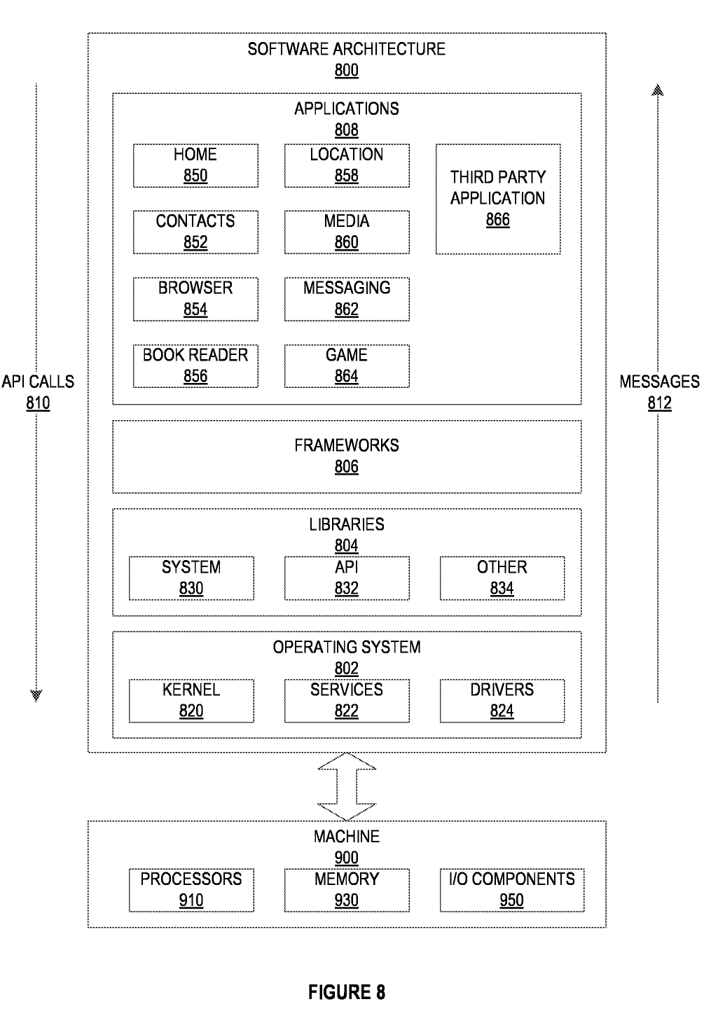

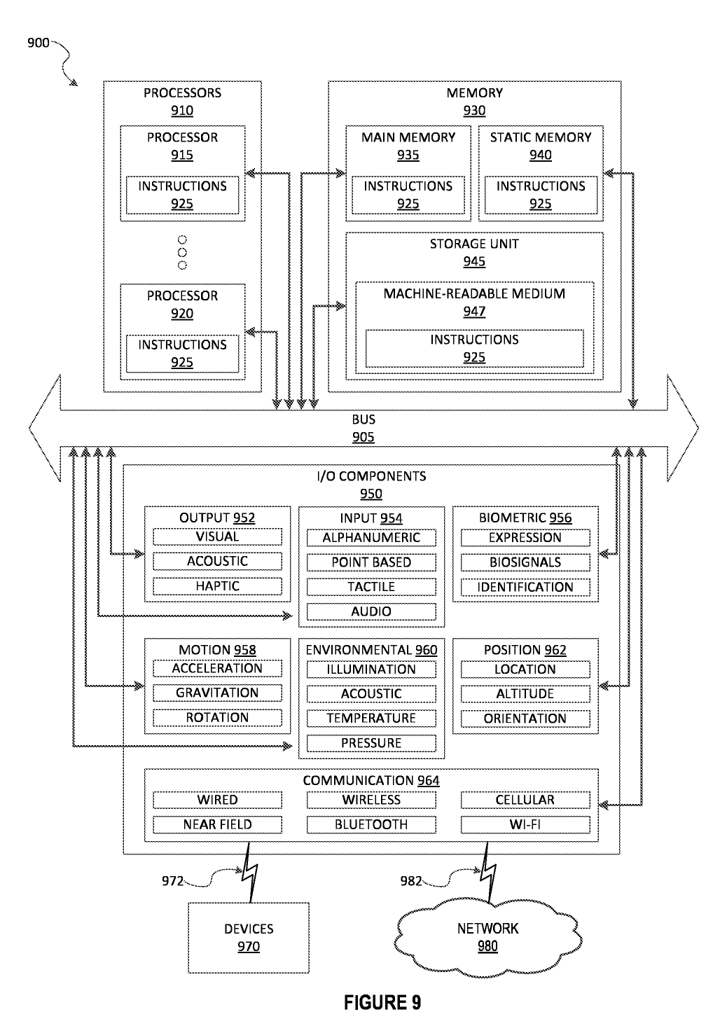

FIG. 8 is a block diagram illustrating an architecture of software 800, which may be installed on any one or more of devices of FIG. 1 (e.g., client system(s) 102). FIG. 8 is merely a non-limiting example of a software architecture and it will be appreciated that many other architectures may be implemented to facilitate the functionality described herein. The software 800 may be executing on hardware such as machine 900 of FIG. 9 that includes processors 910, memory 930, and I/O components 950. In the example architecture of FIG. 8, the software 800 may be conceptualized as a stack of layers where each layer may provide particular functionality. For example, the software 800 may include layers such as an operating system 802, libraries 804, frameworks 806, and applications 808. Operationally, the applications 808 may invoke application programming interface (API) calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 808. The libraries 804 may include system libraries 830 (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 808.

The frameworks 806 may provide a high-level common infrastructure that may be utilized by the applications 808. For example, the frameworks 806 may provide various graphic user interface (GUI) functions, high-level resource management, high-level location services, and so forth. The frameworks 806 may provide a broad spectrum of other APIs that may be utilized by the applications 808, some of which may be specific to a particular operating system or platform.

The applications 808 include a home application 850, a contacts application 852, a browser application 854, a book reader application 856, a location application 858, a media application 860, a messaging application 862, a game application 864, and a broad assortment of other applications such as third party application 866. In a specific example, the third party application 866 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 866 may invoke the API calls 810 provided by the mobile operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 924 (e.g., software, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 924, sequentially or otherwise, that specify actions to be taken by machine 900. Further, while only a single machine 900 is illustrated, the term “machine” shall also be taken to include a collection of machines 900 that individually or jointly execute the instructions 924 to perform any one or more of the methodologies discussed herein.

The machine 900 may include processors 910, memory 930, and I/O components 950, which may be configured to communicate with each other via a bus 905. In an example embodiment, the processors 910 (e.g., a CPU, a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 915 and processor 920 that may execute instructions 925. The term “processor” is intended to include a multi-core processor that may comprise two or more independent processors (also referred to as “cores”) that may execute instructions contemporaneously. Although FIG. 9 shows multiple processors 910, the machine 900 may include a single processor with a single core, a single processor with multiple cores (e.g., a multi-core process), multiple processors with a single core, multiple processors with multiples cores, or any combination thereof.

The memory 930 may include a main memory 935, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, static memory 940, and the processors 910 may be considered as machine-readable media 947.

As used herein, the term “memory” refers to a machine-readable medium 947 able to store data temporarily or permanently and may be taken to include, but not be limited to, random-access memory (RAM), read-only memory (ROM), buffer memory, flash memory, and cache memory. While the machine-readable medium 947 is shown in an example embodiment to be a single medium, the term “machine-readable medium” should be taken to include a single medium or multiple media (e.g., a centralized or distributed database, or associated caches and servers) able to store instructions 925. The term “machine-readable medium” shall also be taken to include any medium, or combination of multiple media, that is capable of storing instructions (e.g., instructions 925) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962 among a wide array of other components. For example, the biometric components 956 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 962 may include location sensor components (e.g., a GPS receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via coupling 982 and coupling 972, respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine and/or any of a wide variety of peripheral devices (e.g., a peripheral device coupled via a USB).

Moreover, the communication components 964 may detect identifiers and/or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 964 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 925 may be transmitted or received over the network 980 using a transmission medium via a network interface device (e.g., a network interface component included in the communication components 964) and utilizing any one of a number of well-known transfer protocols (e.g., HTTP). Similarly, the instructions 925 may be transmitted and/or received using a transmission medium via the coupling 972 (e.g., a peer-to-peer coupling) to devices 970. The term “transmission medium” shall be taken to include any intangible medium that is capable of storing, encoding, or carrying instructions 925 for execution by the machine 900, and includes digital or analog communications signals or other intangible medium to facilitate communication of such software.

Furthermore, the machine-readable medium 947 is non-transitory (in other words, not having any transitory signals) in that it does not embody a propagating signal. However, labeling the machine-readable medium 947 as “non-transitory” should not be construed to mean that the medium is incapable of movement; the medium 947 should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
storing organization data for a plurality of organizations in a database located at a social networking system;
receiving a content marketing score request from a first organization in the plurality of organizations;
retrieving, from the databased located at the social networking system, organization data for the first organization and one or more other organizations;
determining, for the first organization, one or more peer organizations based on the organization data retrieved from the database located at the social networking system;
automatically generating content marketing scores for the first organization and the one or more peer organizations; and
transmitting the content marketing scores for the first organization and the one or more peer organizations to a computer system associated with the first organization.

2. The method of claim 1, wherein the content marketing score request is received from the computer system associated with the first organization.

3. The method of claim 1, wherein organization data includes business description data, including, but not limited to, a size of the organization, a location of the organization, and a business sector of the organization.

4. The method of claim 1, wherein organization data includes social interaction data for content associated with the organization.

5. The method of claim 1, wherein organization data includes a list of members associated with each organization and one or more social connections of those members.

6. The method of claim 1, wherein determining one or more peer organizations comprises:
receiving a list of peer group organizations from the requesting first organization.

7. The method of claim 1, wherein determining one or more peer organizations comprises:
identifying one or more members of the social networking system associated with the first organization;
based on one or more social connections of the one or more members associated with the first organization, generating a closeness score for one or more other organizations, wherein the closeness score for a particular organization represents a number of members associated with the particular organization that have social connections to the one or more members associated with the first organization; and
selecting a predetermined number of organizations as peer organizations based on each organizations closeness score.

8. The method of claim 3, wherein determining one or more peer organizations comprises:
identifying, based on stored business description data, one or more peer organizations with business description data similar to the first organization.

9. The method of claim 1, wherein generating content marketing scores for the first organization and the one or more peer organizations further comprises:
determining a number of engagement events associated with social content associated with an organization;
determining a number of members in an active target audience; and
determining a ratio of unique engagement events to unique members in an active target audience.

10. The method of claim 1, wherein prior to transmitting the content marketing scores, automatically generating a presentation to present the content marketing scores for the first organization and the group of peer organizations.

11. The method of claim 1, wherein content marketing scores are generated such that a content marketing score for a first organization represents a relative position of the first organization in the group of peer organizations.

12. The method of claim 9, wherein the active target audience is customized based on the request of the first organization.

13. A system comprising:
one or more processors;
memory; and
one or more programs stored in the memory, the one or more programs comprising instructions for:
storing organization data for a plurality of organizations in a database located at a social networking system;
receiving a content marketing score request from a first organization in the plurality of organizations;
retrieving, from the databased located at the social networking system, organization data for the first organization and one or more other organizations;
determining, for the first organization, one or more peer organizations based on the organization data retrieved from the database located at the social networking system;
automatically generating content marketing scores for the first organization and the one or more peer organizations; and
transmitting the content marketing scores for the first organization and the one or more peer organizations to a computer system associated with the first organization.

14. The system of claim 13, wherein the content marketing score request is received from the computer system associated with the first organization.

15. The system of claim 13, wherein organization data includes business description data, including, but not limited to, a size of the organization, a location of the organization, and a business sector of the organization.

16. The system of claim 13, wherein organization data includes social interaction data for content associated with the organization.

17. A non-transitory computer readable storage medium storing one or more programs for execution by one or more processors, the one or more programs comprising instructions for:
storing organization data for a plurality of organizations in a database located at a social networking system;
receiving a content marketing score request from a first organization in the plurality of organizations;
retrieving, from the databased located at the social networking system, organization data for the first organization and one or more other organizations;
determining, for the first organization, one or more peer organizations based on the organization data retrieved from the database located at the social networking system;
automatically generating content marketing scores for the first organization and the one or more peer organizations; and
transmitting the content marketing scores for the first organization and the one or more peer organizations to a computer system associated with the first organization.

18. The non-transitory computer readable storage medium of claim 17, wherein the content marketing score request is received from the computer system associated with the first organization.

19. The non-transitory computer readable storage medium of claim 17, wherein organization data includes business description data, including, but not limited to, a size of the organization, a location of the organization, and a business sector of the organization.

20. The non-transitory computer readable storage medium of claim 17, wherein organization data includes social interaction data for content associated with the organization.
